(19) United States
(12) Patent Application Publication
(10) Pub. No.: US 2010/0195058 A1
(43) Pub. Date: Aug. 5, 2010

(54) LASER SCANNING PROJECTION DEVICE

(75) Inventor: Arnd Ritz, Heinsberg (DE)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/665,118

(22) PCT Filed: Jun. 25, 2008
(86) PCT No.: PCT/IB2008/052529

§ 371 Date: Dec. 17, 2009

(30) Foreign Application Priority Data
Jun. 27, 2007 (EP) 07111156.1

(51) Int. Cl. G03B 21/28

(52) U.S. Cl. 353/31; 353/99

(57) ABSTRACT

The present invention relates to a projection device comprising at least one laser light source (2) and a scanning unit (7) arranged for scanning a projection area with a laser beam emitted from said laser source (2). The laser beam is adapted to be divergent at least when leaving the scanning unit (7) and a re-focusing optical element (9, 13) for focusing or collimating the divergent laser beam is arranged in beam direction behind said scanning unit (7). With the proposed projection device the risk for eye damage when looking into the projection beam is reduced.

### FIELD OF THE INVENTION

The present invention relates to a projection device comprising at least one laser light source and a scanning unit arranged for scanning a projection area with a laser beam emitted from said laser light source. Such laser scanning projection devices are mainly used for image projection but can also be designed for example for optically sensing surface contours or surface patterns.

### BACKGROUND OF THE INVENTION

Laser scanning projection devices, also called laser projectors, which apply 0D light valves, i.e. a modulator of one pixel at a time, in combination with 2D scanning of the laser beam are often referred to as flying spot systems. In these systems typically three laser sources emitting red (R), green (G) and blue (B) light are combined into a single beam which is then scanned over the area of a projection screen. The laser beams of the three primary (RGB) lasers normally are first collimated and made to converge before they are combined into the single beam and directed to the scanning unit, which includes one or several scanning mirrors. Due to the convergence of the beams a small spot is formed on the projection screen allowing the desired image resolution.

According to the amount of light on the screen required for the application, laser beams of high power levels have to be applied. For every 25 lumen (RGB) on the screen, for example, a laser power (RGB) of about 100 mW is required. Such high levels of laser power may be harmful for the eyes of a person that gets into the scanning cone of the projection system and happens to look directly into the beam. While the brightness of the projected image is only dependent on the total laser power averaged over the screen, the risk level for the eye depends in a complicated manner on the system and the laser parameters, such as laser power and duration of the exposure.

US 2005/0035943 A1 discloses a laser scanning projection device including detection means for detecting the presence or absence of an intruding object between the projection device and the projection screen. When such an intrusion is detected by the detection means, the output of the laser beam is lowered to a non-harmful power level.

### SUMMARY OF THE INVENTION

It is an object of the present invention to provide a projection device which lowers the risk for damage of the eye when a person gets into the scanning cone of the projection device and happens to look directly into the beam, and which does not require any detection system.

The object is achieved with the projection device according to claim 1. Advantageous embodiments of this projection device are subject matter of the dependent claims or are disclosed in the subsequent portion of the description.

The proposed projection device comprises at least one laser light source and a scanning unit arranged for scanning a projection area with a laser beam emitted from said laser light source. The laser beam of this proposed device is adapted to be divergent at least when leaving the scanning unit and a refocusing optical element is arranged in beam direction behind said scanning unit which focuses or collimates the divergent beam to a desired beam diameter at the projection area outside of the projection device.

With this combination of the divergent scanning beam and the refocusing optical element behind the scanning unit, the laser spot on the scanning unit appears magnified for a human eye looking directly into the beam in direction of the scanning unit. This reduces the risk of eye damage as is explained in the following.

When a person looks into the scanning beam of a laser projector, two situations may occur. If the eye accommodates to infinity, a minimal spot is formed on the retina which is scanned across the retina forming a line. Therefore, the power of the beam is spread over the line due to the scanning movement, which lowers the risk of damage. In the most hazardous situation for the user the eye is accommodated to the position of the scanning element. In this case, the beam that enters the eye is imaged onto a stationary spot on the retina. The size of the spot is dependent on the size of the beam spot on the scanning element. Since this spot does not move on the retina, the eye may be damaged.

The present invention is based on the fact that a larger size of the source, in this case the size of the diameter of the laser beam on the scanning element, produces a larger image of the source on the retina. This distributes the applied laser power over a larger area of the retina and thus reduces the hazard level by reducing the power density on the retina, which in combination with the exposure time is the most crucial parameter for setting damages. Generally, the larger spot on the scanning element, in particular a scanning mirror, could be achieved by increasing the diameter of a collimated laser beam directed to the scanning unit. Practical sizes of scanning mirrors however are limited due to the fast movements (in the range between 10 and 100 kHz) which are required for scanning. The present invention therefore increases the effective size of the scanning element and the source, i.e. the beam spot on the scanning element, by optical means. Due to this optical means, the apparent size of the laser source, as seen by the user when looking into the beam and focusing to the smallest image of the source, is increased and therefore less harmful to the eye. This increases the safety of the projection device. On the other hand, at constant safety level the application of the present invention allows higher laser powers and brighter images.

The magnification of the apparent size of the scanning element for a person looking into the beam in the direction of the scanning element is achieved by making the beam diverge at least when leaving the scanning unit and by introducing a further optical element to refocus the beam onto the projection screen.

The beam divergence can be achieved by different measures. Generally the laser beam is emitted by a laser light source with a certain divergence. In one embodiment of the present invention, this divergent beam is not collimated or converged by optical elements before impinging on the scanning unit. Therefore, this laser beam leaves the scanning unit as a divergent beam.

In a further embodiment, optical beam forming elements, in particular one or several lenses or curved mirrors, are arranged between the one or several laser light sources and the scanning unit. These optical beam forming elements are adapted to form a divergent beam directed to the scanning unit. This may be achieved for example with a collimating optics which is designed to not completely collimate the beam emitted by the laser source(s). This may also be achieved for example with a common collimating optics and an additional optical element diverging the collimated laser beam before being directed to the scanning unit.

In a further embodiment, at least one, preferably the last in beam direction, of the scanning mirrors of the scanning unit, which may include one or several scanning mirrors, is designed to have a convex shape diverging an incoming laser beam upon reflection. Dependent on the convexity of this mirror, the incoming laser beam, i.e. the laser beam coming from the one or several laser light sources, may be collimated, convergent or already slightly divergent.

The scanning unit of the proposed projection device may be a 1D or 2D scanning unit constructed in a known manner and may contain one or several scanning mirrors or other scanning elements. This scanning unit may comprise for example a rotating polygon mirror wheel for one scanning direction and a consecutive tiltable scanning mirror for the other scanning direction or a scanning mirror tiltable in both scanning directions.

In one of the preferred embodiments, the refocusing optical element behind the scanning unit, i.e. between the scanning unit and the projection area outside of the projection device, is a concave mirror. Compared to a refocusing lens a concave mirror does not produce chromatic aberrations.

The proposed projection device may be formed as a handheld device and may also be included in other handheld devices like smart phones or PDA's (Personal Digital Assistants). The invention, however, is not restricted to handheld devices. For image projection applications the device preferably comprises at least three laser light sources emitting red (R), green (G) and blue (B) light. The laser beams emitted from these laser light sources is then combined in a known manner to a single laser beam and directed to the scanning unit.

These and other aspects of the invention will be apparent from and elucidated with reference to the embodiments described herein after.

### BRIEF DESCRIPTION OF THE DRAWINGS

The proposed projection device is described in the following by way of examples in connection with the accompanying figures without limiting the scope of protection as defined by the claims. The figures show:

FIG. 1 a schematic view of an example of the proposed projection device;

FIG. 2 a schematic view showing a ray trace of an example of the proposed projection device;

FIG. 3 a schematic view showing optical details of an example of the proposed projection device; and

FIG. 4 showing three exemplary embodiments for forming a divergent laser beam leaving the scanning mirror.

### DETAILED DESCRIPTION OF EMBODIMENTS

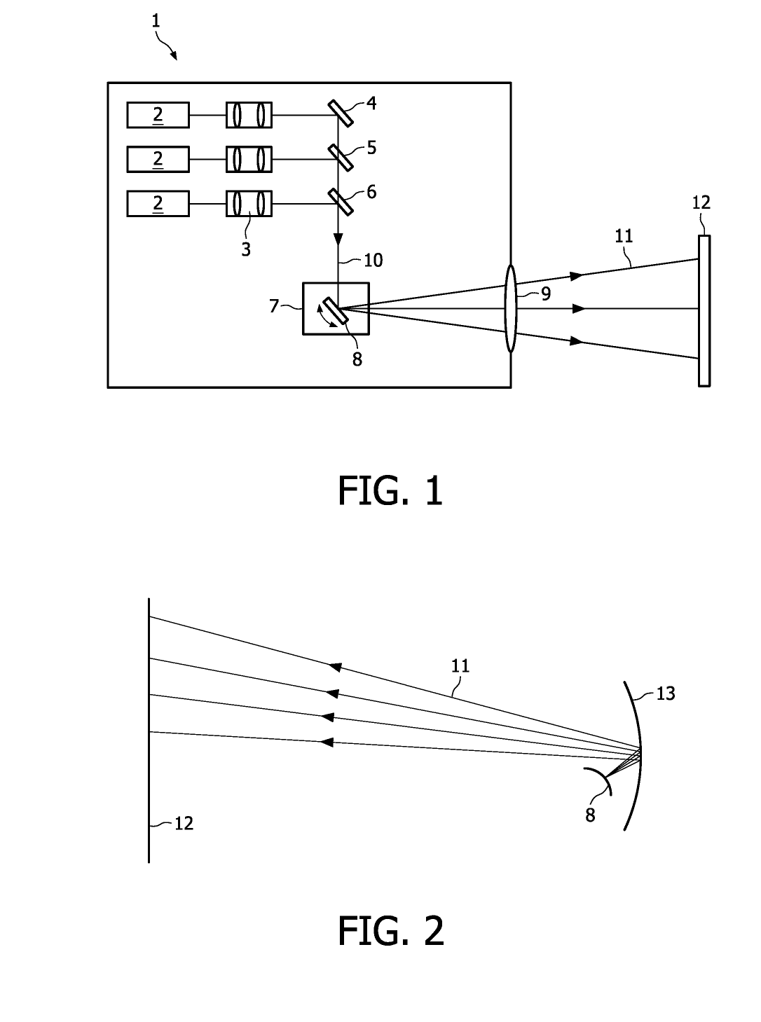

FIG. 1 is a schematic view of an example of the projection device 1 according the present invention. In this device 1 three laser light sources 2 emitting red (R), green (G) and blue (B) laser light beams are included. The laser light sources 2 may be for example laser diodes. The divergent laser beams emitted by these laser light sources 2 are collimated by a collimating optics 3 and combined to form one single laser beam 10. The combination is made via dielectric mirrors 4, 5, 6. Dielectric mirror 4 is designed to reflect light in the red wavelength region. Dielectric mirror 5 reflects in the green wavelength region and is transparent in the red wavelength region, whereas dielectric mirror 6 reflects in the blue wavelength region and is transparent in the red and green wavelength regions. The combined single laser beam 10 is directed to a 2D scanning unit 7, which contains at least one scanning mirror 8. In FIG. 1 only for illustrative purposes one scanning mirror 8 is depicted, which is tiltable in the direction of the arrow. The scanning mirror 8 scans a projection screen 12 outside of the device 1 with the laser beam 11 leaving the scanning unit 7. In beam direction behind the scanning unit 7 a refocusing optical element 9 is arranged which focuses or collimates the divergent laser beam leaving the scanning unit 7.

With such a projection device 1, a colored two dimensional image may be projected to the projection screen 12 by appropriately controlling the intensity of the red, green and blue radiation of the laser light sources 2 dependent on the scanning movement of the scanning mirror(s) of the scanning unit 7.

In the embodiment shown in FIG. 2 a collimated beam is made diverging by a convex shaped scanning mirror 8. After redirection by the scanning mirror 8 the beam 11 is reflected and focused onto the projection screen 12 by a concave mirror 13. The further components of the projection device of this embodiment are not shown. They may be arranged like in the schematic view of FIG. 1.

The single collimated laser beam impinging on the scanning mirror 8 is directed to the concave mirror 13 which reflects the scanning light beam 11 to the screen. Only for illustrative purposes, four different light paths according to four different scanning positions of the scanning mirror are shown. As can also be recognized from this figure, the scanning laser beam 11 has a larger beam diameter at the concave mirror 13 than at the projection screen 12 due to the focusing properties of this concave mirror 13.

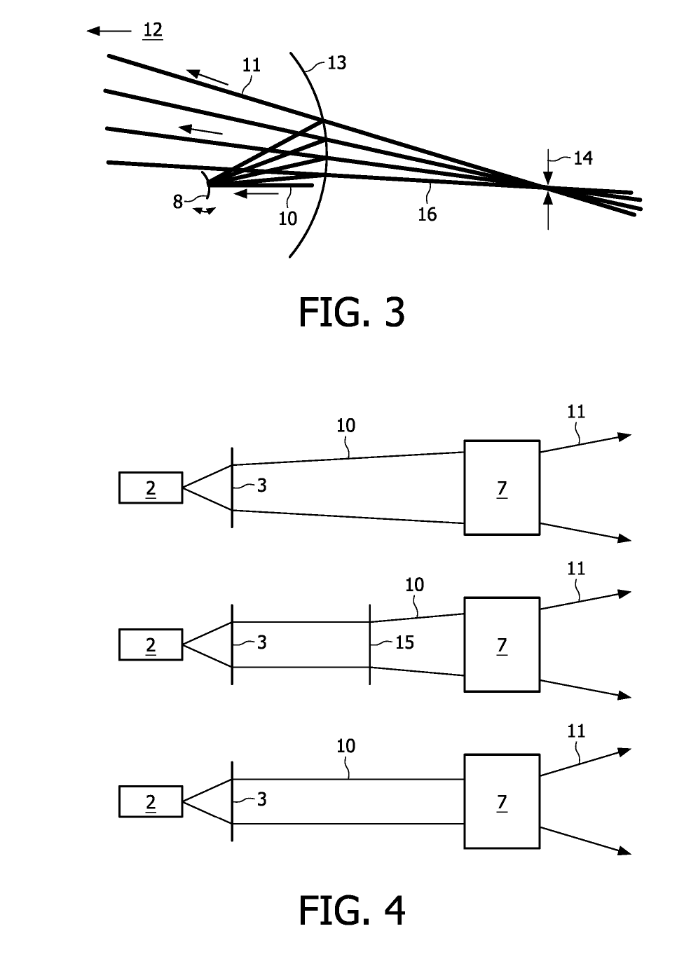

FIG. 3 shows a detail of this embodiment with the four different scanning positions of FIG. 2. The scanning mirror 8 has a convex shape. Therefore, the incoming collimated laser beam 10 is diverged by the scanning mirror 8 as shown in the figure. The diverged laser beam 11 is directed to the concave mirror 13 which reflects and refocuses this beam towards the projection screen 12.

A person looking into the scanning laser beam 11 in the direction of the concave mirror 13 sees an enlarged beam spot 14, which is magnified with respect to the beam spot on the scanning mirror 8, as indicated schematically by the backwards elongated virtual light beams 16. For example, to give an impression on possible dimensions, with a radius of curvature of the scanning mirror 8 of about 60 mm and a mean radius of the concave mirror 13 of about 120 mm and a distance between the scanning mirror 8 and the concave mirror 13 of about 25 mm a magnification of about 2 of this beam spot can be achieved. Such a magnification significantly lowers the risk for damaging the eye when looking into the beam.

A person looking into the scanning laser beam and focusing at the image of the scanning mirror or concave mirror sees an enlarged image of the laser source, resulting in a reduced power density on the retina. The apparent source is furthermore recessed from the observer. The greater distance from source to eye also increases safety. The area of the scanned cone of the laser beam at the exit of the projection device is much larger than it would be without the additional concave mirror 13. This enlarged scan area reduces the amount of laser power that can be collected by the eye.

In the embodiment of FIGS. 2 and 3 the concave mirror 13 and the scanning mirror 8 are displaced according to one another in the direction vertical to the plane of the figure, in order to allow the incoming laser beam 10 to pass the concave mirror 13. Nevertheless, also other constructions can be provided, for example with a small hole in the concave mirror 13 through which the incoming laser beam 10 may pass to the scanning mirror 8.

Independent of the divergent properties of the laser beam, the optical elements between the laser source(s) 2 and the scanning unit 7 are preferably arranged and designed to achieve a diameter of the laser beam at the scanning unit 7 which is as large as possible for reliable operation of the device.

FIG. 4 shows three different possibilities for achieving a divergent laser beam 11 leaving the scanning unit 7. One possibility is to adapt the collimating optics 3 such that the laser beam emitted by the laser source 2 is not fully collimated but remains divergent. This divergent beam is then directed to the scanning unit 7. A further possibility is to collimate the laser beam emitted by laser source 2 and to add a diverging optical element 15, in particular a diverging lens or mirror, in order to form a diverging laser beam which is directed to the scanning unit 7. As a third possibility shown in FIG. 4, a scanning mirror of the scanning unit 7 has a convex shape. The laser beam emitted by the laser source 2 is collimated with a collimating optics 3 and the collimated or converging laser beam is directed to the scanning unit 7. Due to the convex shape of the scanning mirror the scanning unit 7 diverges this laser beam in the desired manner.

While the invention has been illustrated and described in detail in the drawings and forgoing description, such illustration and description are to be considered illustrative or exemplary and not restrictive, the invention is not limited to the disclosed embodiments. The different embodiments described above and in the claims can also be combined. Other variations to the disclosed embodiments can be understood and effected by those skilled in the art in practicing the claimed invention, from a study of the drawings, the disclosure and the appended claims. For example, although the proposed projection device has been described in these embodiments with three laser sources emitting red, green and blue light, the projection device may also include more than three or less than three laser sources. It may for example also be formed of only one laser source which then produces a monochromatic image on the screen.

In the claims, the word “comprising” does not exclude other elements or steps, and the indefinite article “a” or “an” does not exclude a plurality. The mere fact that measures are recited in mutually different dependent claims does not indicate that a combination of these measures can not be used to advantage. Any reference signs in the claims should not be construed as limiting the scope of these claims.

### LIST OF REFERENCE SIGNS

1 projection device
2 laser light source
3 collimating optics
4 dielectric mirror
5 dielectric mirror
6 dielectric mirror
7 scanning unit
8 scanning mirror
9 refocusing optical element
10 incoming single laser beam
11 scanning laser beam
12 projection screen
13 concave mirror
14 enlarged effective spot
15 diverging optical element
16 backwards elongated virtual light beams

1. A projection device comprising at least one laser light source and a scanning unit arranged for scanning a projection area with a laser beam emitted from said laser source, wherein the laser beam is adapted to be divergent at least when leaving the scanning unit and wherein a refocusing optical element for focusing or collimating the divergent laser beam is arranged in beam direction behind said scanning unit.

2. The projection device according to claim 1, wherein the refocusing optical element is a concave mirror.

3. The projection device according to claim 1, wherein the scanning unit comprises a scanning mirror having a convex shape.

4. The projection device according to claim 1, wherein optical beam forming elements are arranged between the laser source and the scanning unit, said optical beam forming elements being designed and arranged to form a diverging laser beam which is directed to said scanning unit.

5. The projection device according to claim 1, wherein three laser sources are included in the device emitting three laser beams of different wavelengths, said three laser beams being combined to a single laser beam which is directed to the scanning unit.

6. The projection device according to claim 1, wherein the divergence of the laser beam leaving the scanning unit and the refocusing optical element are adapted such that a beam spot of the laser beam on a scanning mirror of the scanning unit appears enlarged by at least a factor of 1.3 to a person looking into the beam in the direction of the refocusing optical element.

7. The projection device according to claim 6, wherein the divergence of the laser beam leaving the scanning unit and the refocusing optical element are adapted such that a beam spot of the laser beam on a scanning mirror of the scanning unit appears enlarged by at least a factor of 1.5 to a person looking into the beam in the direction of the refocusing optical element.
